(19) United States
(12) Patent Application Publication
(10) Pub. No.: US 2020/0024163 A1
(43) Pub. Date: Jan. 23, 2020

(54) WASTEWATER FILTRATION METHOD AND SYSTEM

(71) Applicant: Shravya Jasti, Holmdel, NJ (US)

(72) Inventor: Shravya Jasti, Holmdel, NJ (US)

(21) Appl. No.: 16/507,781

(22) Filed: Jul. 10, 2019

Related U.S. Application Data
(60) Provisional application No. 62/702,333, filed on Jul. 23, 2018.

(51) Int. Cl. C02F 1/50; C02F 1/28; C02F 1/42; B01J 47/014; B01J 39/04; B01J 39/18; B01J 20/12; B01J 20/02

(52) U.S. Cl. CPC C02F 1/505; C02F 1/281; C02F 1/42; B01J 47/014; C02F 2303/04; B01J 39/18; B01J 20/12; B01J 20/0237; B01J 39/04

(57) ABSTRACT

The invention is a method of and system for removing bacteria and other contaminants in water by utilizing bentonite clay impregnated with metal ion, such as silver or copper ion. The method and system may alternatively or additionally include a cation exchange resin impregnated with metal ion, such as silver or copper ion.

### CROSS REFERENCE TO RELATED APPLICATIONS

This application claims priority to and the benefit of U.S. Provisional Application No. 62/702,333 filed Jul. 23, 2018, which is hereby incorporated by reference in its entirety.

### FEDERALLY SPONSORED RESEARCH OR DEVELOPMENT

None.

### TECHNICAL FIELD

The present invention relates to a wastewater filtration system and method, and specifically a wastewater filtration system and method using copper and silver ion impregnated substances.

### BACKGROUND

Clean water is indispensable to life. However, the lack of clean water is undoubtedly one of the most prevalent and disastrous issues of our time. Commercial filters such as Brita filters are too expensive for a vast majority of people in the world to afford, where hundreds of millions of people lack access to clean water. Impure water can contain cations and heavy metals that are harmful to humans. It can also contain bacteria in large amounts that are also dangerous.

Scientists around the world have developed methods to purify water, such as using UV light or charcoal filters. However, not all processes are cost-effective, leaving many in impoverished areas without access to these devices that could provide a higher quality of life.

Potters for Peace, an organization focused on creating access to clean water, coats the outside of ceramic pots intended to purify water with a silver ion solution, which has long been known for its ability to kill waterborne bacteria. While the ceramic pots developed by Potters for Peace have been shown to successfully remove bacteria, it has not been shown that the pots can remove organic contaminants.

Previous studies on modified bentonite have been used to remove BTEX compounds, toxic compounds found in gasoline, from contaminated soil. Another study performed by the Mpenyana-Monyatsi group coated cost-effective materials such as cation and anion resins with silver nanoparticles, obtaining a high removal rates for a single strain of bacteria.

Ion substances take harmful minerals out of the water and replace them with hydrogen in the water. Deionization does not, however, significantly remove uncharged organic molecules, viruses or bacteria, except by incidental trapping in the resin. An ion-exchange resin or ion-exchange polymer is a resin or polymer that acts as a medium for ion exchange. It is an insoluble matrix normally in the form of small microbeads fabricated from an organic polymer substrate. Previous methods and apparatuses for treating water used ion exchange resin did not eliminate both organic waste and bacteria.

Bentonite is an absorbent phyllosilicate clay consisting mostly of montmorillonite. There exists a substantial amount of literature about bentonite or montmorillonite used as a water filter because of its absorption of methylene blue, a lab substitute for organic waste. The BATIS Project has explored the uses of bentonite as a water filter. However, bentonite as a water filter alone does not have the effect of eliminating bacterial colonies in water.

### SUMMARY

The present invention is a method of removing bacteria and contaminants in wastewater by a series of filters utilizing bentonite clay impregnated with silver ion and cation exchange resin impregnated with copper.

### BRIEF DESCRIPTION OF THE DRAWINGS

For a more in-depth understanding of the nature of the present invention, reference should be given to the following detailed description taken in connection with the accompanying drawings in which:

FIG. 1 depicts the invention filtration system with exchangeable resins and bentonite.

FIG. 2 depicts the average number of bacterial colonies in a quadrant of agar plate from full-strength samples comparing a control to nine other samples, including the invention.

FIG. 3 depicts the average number of large bacteria colonies in a quadrant of agar plate from dilution samples comparing a control to nine other samples, including the invention.

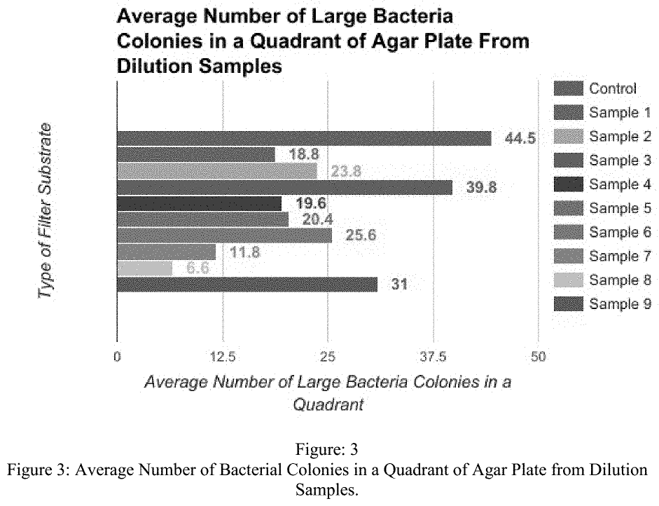

FIG. 4 depicts bacterial plate images of a control and nine other samples of Cation Resin+NH₃ (added after)+AgNO₃ (Sample 1), Cation Resin+NH₃ (added before)+AgNO₃ (Sample 2), Cation Resin+AgNO₃ (Sample 3), Bentonite Clay+AgNO₃ (Sample 4), Cation Resin+CuSO₄ (Sample 5), Bentonite Clay+CuSO₄ (Sample 6), Charcoal+CuSO₄ (Sample 7), Fe filings (Sample 8), and Charcoal+AgNO₃ (Sample 9).

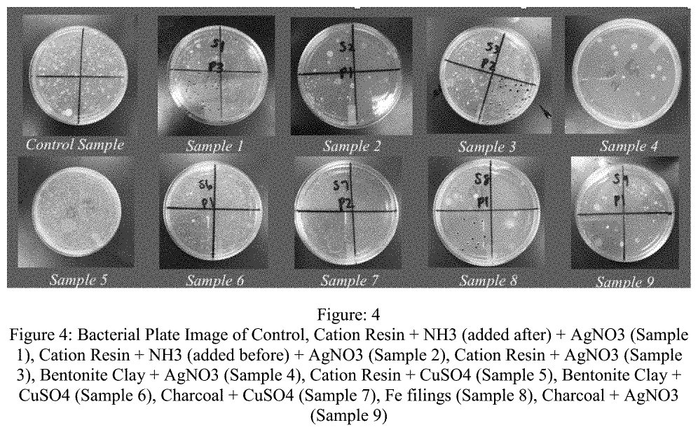

FIG. 5 depicts water sample images post-treatment of control, the untreated methylene blue water, and samples of Cation Resin+NH₃ (added after)+AgNO₃ (Sample 1), Cation Resin+NH₃ (added before)+AgNO₃ (Sample 2), Cation Resin+AgNO₃ (Sample 3), Bentonite Clay+AgNO₃ (Sample 4), Cation Resin+CuSO₄ (Sample 5), Bentonite Clay+CuSO₄ (Sample 6), Charcoal+CuSO₄ (Sample 7), Fe filings (Sample 8), and Charcoal+AgNO₃ (Sample 9).

FIG. 6 depicts a methylene blue standard solution Beer's law calibration curve. The Beer's law calibration curve is used to determine the concentration of methylene blue present in solution following that the absorbance of a solution directly proportional to the concentration, according to Beer's law.

FIG. 7 depicts a table of the Beer's Law absorbances and concentrations post-treatment of control, the untreated methylene blue water, and samples of Cation Resin+NH₃ (added after)+AgNO₃ (Sample 1), Cation Resin+NH₃ (added before)+AgNO₃ (Sample 2), Cation Resin+AgNO₃ (Sample 3), Bentonite Clay+AgNO₃ (Sample 4), Cation Resin+CuSO₄ (Sample 5), Bentonite Clay+CuSO₄ (Sample 6), Charcoal+CuSO₄ (Sample 7), Fe filings (Sample 8), and Charcoal+AgNO₃ (Sample 9).

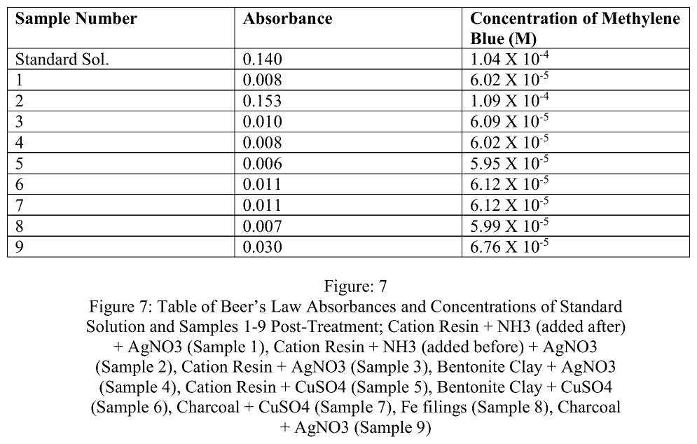

Like reference numerals refer to like parts throughout the several views of the drawings.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but to the contrary, the disclosure is to cover all modifications, equivalents and alternatives falling within the spirit and scope of this disclosure.

### DETAILED DESCRIPTION

The present invention utilizes copper (II) ion or silver (I) ion impregnated substrates such as bentonite clay, cation exchange resin, and charcoal as well as iron filings in removing bacteria and organic waste from wastewater. Each substrate was tested for ability to remove bacteria and organic contaminants from wastewater effluent. Filters were constructed using small plastic containers, glass wool, glass beads and each filter substrate. Each of the three substrates was tested for ability to remove bacteria by passing 50. mL of wastewater effluent through each one. Using the spread plate technique, different strains of bacteria were killed by specific filter substrates with silver ion impregnated bentonite clay as the most effective in removing the large bacterial colonies. Methylene blue (simulated organic waste) was decolorized immediately by each filter. Using Beer's Law, the decrease in concentration in each trial was calculated. Copper impregnated cation exchange resin was the most effective in removing the simulated organic waste. This new method of impregnating the metal ion into bentonite and cation resins presented to be a cheaper, more effective alternative in removing bacteria and organic waste from water than more expensive commercial filters such as Brita filters.

One of the most common and preventable issues of our time is the lack of access to clean water. Millions lack access and scientists around the world have developed several methods to purify water whether it is by using UV light or charcoal filters. However, not all processes are cost-effective, leading many to not have access to filtration devices that could potentially save their lives. This study explored the effectiveness and novel impregnation of copper (II) ion or silver (I) ion in substrates of bentonite and cation exchange resins to remove bacterial and organic waste from wastewater. After impregnation, the substrates were filtered, washed, dried, and ground up to be used as filter substrates. Filters were constructed using small plastic containers, glass wool, glass beads and filter substrate. The impregnated substrates were tested for ability to remove bacteria by passing 50. mL of wastewater effluent. Two protocols were performed to analyze bacterial content post-filtration: dilution and full-strength. Using spread plate technique, each sample was tested for bacterial content. The large colonies were counted as a measure of the removal efficiency of bacteria from sewage water. To evaluate the effectiveness of the substrates in removal of organic waste from wastewater, a dilute solution of methylene blue (to simulate organic waste) was passed through each filter. Each filter decolorized the blue methylene blue solution immediately. Using Beer's Law protocol, the decrease in concentration in each trial was calculated. Water samples passed through the impregnated filter substrates had fewer bacterial colonies present, different strains of bacteria were killed by specific substrates, and reduced concentration of methylene blue solution than the sewage water control and standard methylene blue solution. Silver ion impregnated bentonite clay as the most effective in removing the large bacterial colonies. The copper impregnated cation exchange resin was the most effective in removing methylene blue.

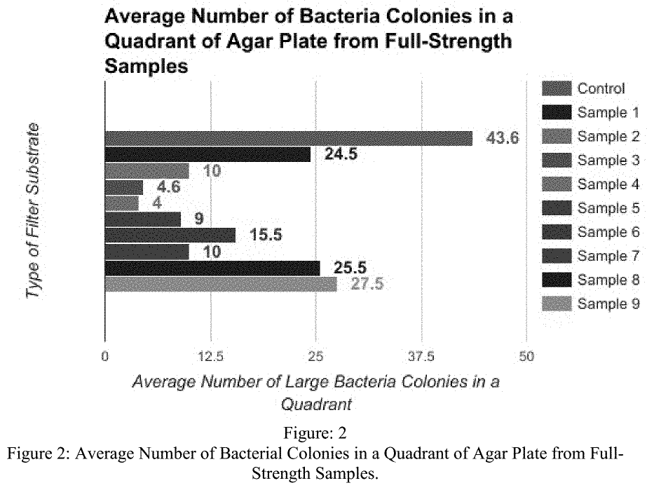

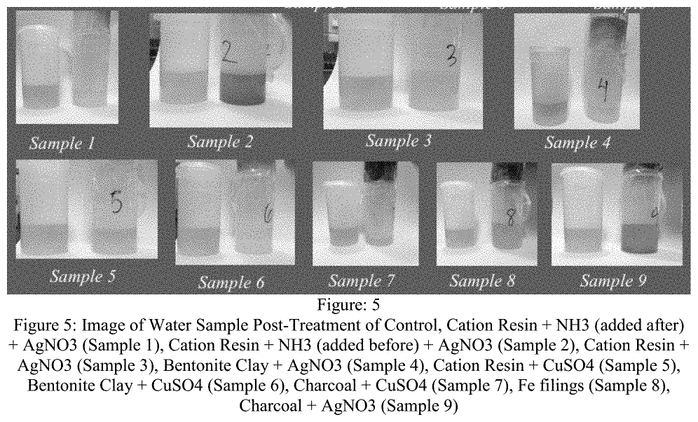

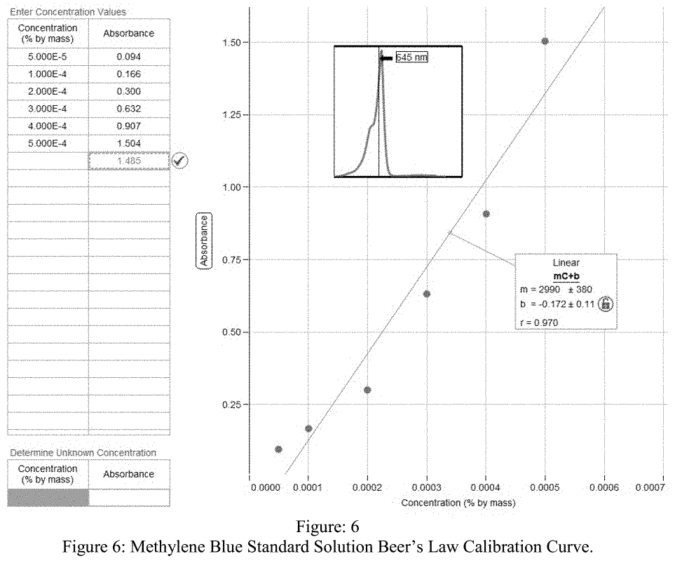

After plating the samples, the author was able to obtain that all of the samples were effective in removing bacteria, but in the full-strength samples (FIG. 2), the most effective substrate in removing large colonies was Sample 4, Bentonite Clay with AgNO3. From each of the bacterial plates, she was able to observe that different strains of bacteria were killed by different substrates. As can be seen in the pictures of the silver impregnated cation resin and bentonite, all of the small bacterial colonies were killed off, but in the copper impregnated all of the large bacterial colonies were removed (FIG. 2, 3, 4). In the second part of the experiment, methylene blue was used to simulate organic molecules such as the toxic BTEX compounds because it is colored, and if removed, would result in colorless filtrates. The author instantly saw that the methylene blue was removed immediately after the solution was passed through the filtration system (FIG. 5). Using a Beer's Law calibration curve, the absorbances and concentrations of the samples were calculated (FIG. 6). Each of the substrates was successful in removing methylene blue. The copper impregnated cation resin had the lowest absorbance concentration of methylene blue. One anomaly that was encountered was Sample 2 (Cation Resin+NH₃ (added before)+AgNO₃) because visibly it appeared colorless but had a higher absorbance than the control due to suspended solids in the water that we could not remove even after filtering it. The Fe filings substrate had a yellowish tint to the water because some of the iron must have passed through when water was being poured into the filter.

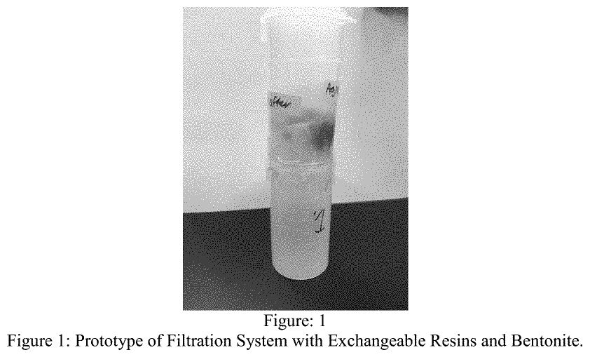

To clean the bentonite clay stir 200 g of it in 150 mL of 30% HNO₃ solution. Decant solution and rinse 5 times with distilled water. Test acidity using pH test and by reacting NaHCO₃ with the nitric acid solution. Dry out in oven at 250° F. for 8 hours. In all preparations involving silver ion, the samples are wrapped in aluminum foil to prevent photo-reduction of silver ions. Prepare 1 mM stock solution: Add 170 mg AgNO₃ to 1 L distilled water. Prepare dilutions of 0.1 mM AgNO₃: Add 25 mL of stock solution into 250 mL of distilled water in a volumetric flask. Invert flask several times to mix solution. Add 10 mL of a 25% NH₃ solution to a dilution of AgNO₃ before stirring to form silver ammonia complex. Add to 10 g of cation resin. Resin beads should change color from yellow to black because of the formation of Ag₂O. 10 g of each substrate immersed in each dilution (125 mL) for 24 hours. Stir for 168 hours (7 days) in dark conditions. Filter charcoal & cation resin through gravity filtration. Filter bentonite using suction filtration. Rinse 3 times with distilled water. Dry out in oven at 250° F. for 8 hours. Repeat substrate impregnation steps for CuSO₄.5H₂O. Crush all substrates using mortar and pestle into fine powder. Also, use iron filings as substrate. To prepare prototype filtration systems, drill small holes into snap-seal plastic containers. Add 1 cm of glass wool to the lower end, place entire substrate on top of the wool, and add 10 glass beads. Glass beads added so substrates do not over pile in the container. Be careful when handling glass wool. Wear surgical mask, goggles, and gloves. Sterilize all plastic containers by washing out with isopropanol. Place sterilized plastic container underneath the filtration container for water to pass through it. Connect containers using heavy duty tape (FIG. 1).

Overall, it is concluded that silver and copper ion impregnated bentonite clay and cation resins presented to be cheaper and more effective alternatives in removing bacteria and organic contaminants from water than the more commonly used charcoal, which again is used in Brita filters. The author proposes a filter kit that could be easily distributed. Every filter would contain a total of 100 g of treated bentonite clay. If the clay is treated with AgNO₃, it will cost only $0.05 or 5 cents for the AgNO₃/100 g bentonite clay. If the clay is treated with CuSO₄.5H₂O, it will cost only $0.01 or 1 cent for the CuSO₄.5H₂O. The bentonite clay would be cleaned with a 30% solution of HNO₃ prior to impregnation with the copper or silver ion. This treatment would not cost more than $0.05/100 g bentonite clay. Each filter setup will be the size of a Brita filter, and each kit will contain 50 g of bentonite clay+AgNO₃ and 50 g of bentonite clay+CuSO₄.5H₂O. The materials needed to assemble a filtration system would be packaged into a small, easy-to-build kit with the following components: 50 g of bentonite clay+AgNO₃ ($0.60), 50 g of bentonite clay+CuSO₄.5H₂O ($0.60), coffee filter ($0.01/filter), plastic mesh ($0.05/mesh), plastic container of choice ($0.50). The total cost for each filter would be approximately $1.80. This is a sizable cost difference from a Brita filter, which on average costs $8. In addition, a Brita filter is only able to remove the taste and odor of chlorine from water and heavy metal ions such as zinc, copper, cadmium, and mercury. The filtration system developed in this research project is able to remove both bacteria and organic contaminants from water, while a Brita filter can not do so. While the ceramic pots developed by Potters for Peace has been shown to successfully remove bacteria, they have not shown that these pots can remove organic contaminants. In this study, bentonite clay could remove bacteria and organic molecules.

Copper and silver ion impregnated bentonite and cation resins substrates can not only be used in the field of water contamination, but also in removing the organic and bacterial contaminants from soil.

This is an inexpensive filter that could be implemented easily in rural homes in developing countries. Bentonite and cation resins present a cheaper and more effective alternative in removing bacteria and organic molecules from water than more commonly used filter substrates on the market such as Brita filters, which are too costly for many.

While the ceramic pots developed by Potters for Peace have been shown to successfully remove bacteria, it has not been shown that the pots can remove organic contaminants. This filter can remove both bacteria and organic contaminants.

The Brita filter, a charcoal filter, is only able to remove the taste and odor of chlorine from water and heavy metal ions such as zinc, copper, cadmium, and mercury. This invention, however, is able to remove both bacteria and organic contaminants from water.

Furthermore, the materials for a single filter are quite compact, making them easily distributable for small-scale use, measuring 2 inches by 3.5 inches with the filter alone and 2 inches by 7 inches with the same size receiving device.

Overall, it is concluded that silver and copper ion impregnated bentonite clay and cation resins presented to be cheaper and more effective alternatives in removing bacteria and organic contaminants from water than the more commonly used charcoal, used in Brita filters.

Therefore, this invention expands upon previous research by showing the removal of organic molecules and various bacterial strains from water by impregnating the substrates with the antimicrobial metal ions such as silver and copper.

The filter substrates are made by impregnating bentonite clay with silver ions using an HNO₃ solution and impregnating cation resin with copper by creating a NH₃ solution to a dilution of AgNO₃. This creates the two filter substances. These can be added to other filter materials of glass wool and glass beads for structure and added filtration. It has been found that the combination of these two filters eliminates two major contaminants of water, bacteria and organic waste.

Filters can be constructed using containers, glass wool, glass beads and filter substrate. The prototypes were prepared by drilling small holes into snap-seal plastic containers, adding 1 cm of glass wool to the lower end, placing entire substrate on top of the wool, and adding 10 glass beads. Glass beads were added so that the substrates did not over pile in the container.

For the silver cation exchange resin filter, the silver ions were dissolved in solution and impregnated in resin by the following method. Nitrates were removed from silver nitrate using HCl. In all preparations involving silver ion, the samples are wrapped in aluminum foil to prevent photo-reduction of silver ions. A 1 mM stock solution was prepared by adding 170 mg AgNO₃ to 1 L distilled water. Dilutions of 0.01 mM AgNO₃ were prepared by adding 25 mL stock solution to a flask, mixing the substance by inverting the flask several times. 10 mL of a 25% NH₃ solution was added to a dilution of AgNO₃ before stirring to form silver ammonia complex. Then 10 g of cation resin was added. The resin beads change color from yellow to black because of the formation of Ag₂O. Each substrate was left immersed in each dilution for 24 hours. The substance was stirred over the course of 168 hours (7 days) in dark conditions.

For the copper ion bentonite filter, two hundred grams of bentonite clay was cleaned in 150 mL 30% HNO₃ solution. The solution was decanted and rinsed five times with distilled water. The acidity was tested using a pH test and by reacting NaHCO₃ with the nitric acid solution. The sample was then dried in oven at 250° F. for 8 hours.

Repeat substrate impregnation steps for CuSO₄, obtaining copper ions by dissolving in HCl and then impregnating it in the bentonite clay.

After impregnation, the substrates are filtered, washed, dried, and ground up to be used as filter substrates.

The cation resin was filtered through gravity filtration. The bentonite was filtered using suction filtration. These substrates were rinsed three times with distilled water and dried in oven at 250° F. for 8 hours. Substrates were crushed into a fine powder using a mortar and pestle. Iron filings were used as substrate.

Both full strength and diluted strength samples were prepared, however the full-strength samples were more effective.

The following sample filters were created to find the most effective one: Cation Resin+NH₃ (added after)+AgNO₃; Cation Resin+NH₃ (added before)+AgNO₃; Cation Resin+AgNO₃; Bentonite Clay+AgNO₃; Cation Resin+CuSO₄; Bentonite Clay+CuSO₄; Charcoal+CuSO₄; Fe filings; and, Charcoal+AgNO₃. In research, the impregnated substrates were tested for the ability to remove bacteria by passing 50 mL of wastewater effluent. Using spread plate technique, each sample was tested for bacterial content. The large colonies were counted in order to measure the removal efficiency of bacteria from the sewage water as a result of the filter.

To evaluate the effectiveness of the substrates in removal of organic waste from wastewater, a dilute solution of methylene blue (to simulate organic waste) was passed through each filter. Each filter decolorized the blue methylene blue solution immediately. The decrease in concentration in each trial was calculated using Beer's Law.

Water samples passed through the impregnated filter substrates had fewer bacterial colonies present, different strains of bacteria being killed by specific substrates, and had a reduction in concentration of methylene blue solution than the sewage water control and standard methylene blue solution.

Silver ion impregnated bentonite clay, Sample 4, was the most effective in removing the large bacterial colonies, as shown in FIG. 2. The copper impregnated cation exchange resin, Sample 3, was the most effective in removing methylene blue. Using a Beer's Law calibration curve, the absorbances and concentrations of the samples were calculated. This is shown in FIG. 6.

All publications and patent documents cited in this application are incorporated by reference in pertinent part for all purposes to the same extent as if each individual publication or patent document were so individually denoted. By citation of various references in this document, Applicants do not admit any particular reference is “prior art” to their invention. It is to be appreciated that the foregoing Detailed Description section, and not the Abstract section, is intended to be used to interpret the claims. The Abstract section may set forth one or more, but not all, exemplary embodiments of the present invention as contemplated by the inventor(s), and thus, is not intended to limit the present invention and the appended claims in any way.

The foregoing description of the specific embodiments should fully reveal the general nature of the invention so that others can, by applying knowledge within the skill of the art, readily modify and/or adapt for various applications such specific embodiments, without undue experimentation, without departing from the general concept of the present invention.

Moreover, the breadth and scope of the present invention should not be limited by any of the above-described exemplary and illustrative embodiments, but should similarly be defined only in accordance with the following claims and their equivalents.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents. From the foregoing, it will be seen that this application is one well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

What is claimed is:

1. A system for removing contaminants in water comprising substrates of bentonite clay impregnated with metal ion.

2. The system of claim 1 wherein the bentonite is impregnated with silver.

3. The system of claim 1 wherein the bentonite is impregnated with copper.

4. The system of claim 1 wherein the bentonite is impregnated with silver and copper.

5. The system of claim 1 comprising a cation exchange resin impregnated with metal ion.

6. The system of claim 2 comprising a cation exchange resin impregnated with metal ion.

7. The system of claim 3 comprising a cation exchange resin impregnated with metal ion.

8. The system of claim 4 comprising a cation exchange resin impregnated with metal ion.

9. The system of claim 5 wherein the resin is impregnated with silver.

10. The system of claim 6 wherein the resin is impregnated with silver.

11. The system of claim 7 wherein the resin is impregnated with silver.

12. The system of claim 8 wherein the resin is impregnated with silver.

13. The system of claim 5 wherein the resin is impregnated with copper.

14. The system of claim 6 wherein the resin is impregnated with copper.

15. The system of claim 7 wherein the resin is impregnated with copper.

16. The system of claim 8 wherein the resin is impregnated with copper.

17. The system of claim 5 wherein the resin is impregnated with silver and copper.

18. The system of claim 6 wherein the resin is impregnated with silver and copper.

19. The system of claim 7 wherein the resin is impregnated with silver and copper.

20. The system of claim 8 wherein the resin is impregnated with silver and copper.
